(19) United States
(12) Patent Application Publication
(10) Pub. No.: US 2010/0257027 A1
(43) Pub. Date: Oct. 7, 2010

(54) METHOD AND SYSTEM FOR COLLATING, STORING, ANALYZING AND ENABLING ACCESS TO COLLECTED AND ANALYZED DATA ASSOCIATED WITH BIOLOGICAL AND ENVIRONMENTAL TEST SUBJECTS

(75) Inventors: Michael Mordinson Greenberg, Richmond Hill (CA); John Anthony Godsall, Toronto (CA)

Correspondence Address: PATENT GROUP;C/O DLA PIPER US LLP, 203 N. LASALLE ST., SUITE 1900, CHICAGO, IL, 60601, US

(73) Assignee: FIO Corporation, Toronto (CA)

(21) Appl. No.: 12/670,222

(22) PCT Filed: Jul. 23, 2008
(86) PCT No.: PCT/CA2008/001348

§ 371 Date: May 25, 2010

Related U.S. Application Data
(60) Provisional application No. 60/951,355, filed on Jul. 23, 2007.

(51) Int. Cl. G06F 17/30; G06Q 30/00; G06Q 10/00; G06Q 50/00

(52) U.S. Cl. 705/10; 707/802; 707/783; 705/34; 707/E17.005

(57) ABSTRACT

A method and system arc for collating, storing, analyzing and enabling access to data associated with test subjects. Test data associated with the test subjects it, received via test devices, and transmitted to and stored in a remote database as collected data, where it is analyzed. The analyzed data is stored in the remote database. Remote access to collected or analyzed data is enabled. The system includes the test devices, the remote database, thy test data, a processor to analy7e the collected data, and an access subsystem to enable the remote access. In a peer-to-peer version of the method and system, peer devices are located remotely of the test devices. The peer devices are in communication with the test devices, and a processing subsystem creates a programmed or adaptive response in the peer devices, based upon the collected data received by the test devices.

### FIELD OF THE INVENTION

The present invention relates generally to the field of data collection and analysis, and more specifically, to a method and system for collating, storing, analyzing and enabling access to data associated with biological and environmental test subjects.

### BACKGROUND OF THE INVENTION

A biological sample, such as a drop of blood, is a biological library of information that may provide valuable information about the individual and her environment. A drop of blood may reveal information on what pathogens the individual has been exposed to, specific physiological and/or biochemical states of the individual (e.g., disease states, mineral content, hormonal levels, organ function, and/or drug effectiveness). In the prior art, unless particular information had been anticipated as being directly relevant to the purpose of the blood test, much valuable information may typically have been thrown away after completion of prior art blood tests.

Prior art diagnostic test systems and/or methods may have been predicated on the basis of providing an immediate and/or near-immediate diagnosis on an individual patient basis at the point-of-care. Often, such diagnostic test systems and/or methods may have involved medical tests performed, for example, to aid in the measurement, detection and/or diagnosis of a disease, genetic expression factor, and/or genetic predisposition (alternately, collectively referred to as “test data”). In this manner, prior art test systems and/or methods may have measured the progress and/or recovery from disease, confirmed that the patient is free from disease, ascertained the presence and/or level of a particular substance (e.g., a drug) and/or pathogen within the body, and/or determined the effectiveness of a particular treatment. Prior art medical tests that may have been heretofore performed on patients may have involved physical examinations of the patient conducted by the physician, while others may have involved the taking of a tissue sample or bodily fluids (e.g., saliva, blood, urine) for analysis by a laboratory technician. Regardless of the medical test conducted, however, often times any previously collected data (e.g., pH levels, electrolyte levels, heart rate, blood type, blood pressure, cholesterol levels, presence of an antigen, hormonal levels, x-rays) not required for the test may heretofore have been discarded as extraneous. Furthermore, since data may have been previously collected to test for or diagnose a current medical condition in a particular patient, the collected data for the diagnosis may not have been always kept, or it may not have been be kept in a fashion that allows for ready retrieval and/or analysis for future problems, and/or for epidemiological trends and/or correlations, and/or for immediate communication to other local or regional devices or care-givers.

For example, in the past, when a doctor conducted a diagnostic test on a patient, the results may have been recorded in the patient's file. The data recorded in the patient's file may have been inaccessible due to privacy protection of the patient. Accordingly, the value of previously collected data may have been limited as the data may not have been available for pooling and/or sharing to assist in later tests and/or diagnoses by other doctors for other patients.

Moreover, analyses previously performed on samples and/or data previously collected from patients may have been restricted to a limited number of tests, possibly due to relatively high costs associated with performing multiple tests. In previous medical practice, data collected from patients may have been typically used to confirm a preliminary diagnosis and/or to rule out a possible diagnosis that might have been otherwise arrived at—based upon signs, symptoms and/or medical history gathered at the time the patient had been examined. Specific individual tests may have been required for each type of data collected, so physicians generally may have ordered only those tests that were thought to provide data relevant to the confirmation and/or elimination of the candidate diagnoses. While such prior art practices may have reduced cost, it may also have increased the previous risk of misdiagnoses, especially if the physician had failed to order the correct test(s) on the sample collected from the patient.

There may exist, therefore, a need for a system or method which provides for collection of all, or at least an improved amount, of test data concerning patients. Considering that the data may need to be collected in order to perform diagnoses, it may also be important to provide a system or method which enables comparison of the collected data against a database of previously collected data (e.g., for other patients who have exhibited similar symptoms). In this manner, such a system or method may preferably provide faster and/or more accurate diagnoses, and/or more comprehensive characterization of the disease circumstance. Preferably, such a system or method would protect the privacy of those patients from whom the data is collected.

In addition, on a regional, national or global scale, there also may be a need for a system or method which is capable of assisting in the detection or anticipation of an outbreak of infectious disease, preferably by allowing access to test data collected regionally, nationally or globally. Preferably, such a system or method may provide better systems or methods of identification, prevention, management and/or control of infectious diseases, preferably before levels reach epidemic or pandemic proportions.

Infectious diseases may have been thought to cause more illness or death than cancer and heart disease combined, and/or more economic disruption than all other diseases combined. This thinking may be especially prevalent in today's world of highly complex infectious diseases, which may be more resistant to drugs and/or constantly mutating, and/or which may be readily transportable in their carriers and/or hosts, whether globally and/or locally. Prior art systems or methods of treating infectious diseases may have required ever changing treatment protocols, many of which may be unfamiliar to a large number of doctors. Consequently, there may have been an increased likelihood for infectious diseases to have been misdiagnosed and/or mistreated.

Today, the standard of care in diagnosing many infectious diseases may involve a reliance on old technology. Examples of such technologies which are still in use may include light microscopes for direct demonstration of pathogens, as well as stains first identified in the 1800s—including the Giemsa stain (named after Gustav Giemsa, 1867-1948) for malaria and the acid fast stain for tuberculosis. Other dated technologies, which may nonetheless still be in use, include techniques for culturing organisms on agar filled petri dishes (i.e., much the same as that used by Louis Pasteur, 1822-1895), as well as slow and tedious biochemical identification and/or susceptibility testing. Also, in many cases, analyses of blood and/or other clinical samples from patients may not be performed at the point-of-care—instead the samples may be sent to remote labs where technicians analyze samples based on information provided by the attending physician and/or using classic microbiology techniques. As such, many agents not suspected, and/or not specifically requested, by the attending physician may not be investigated and/or identified.

Although there are more complex tests (e.g., gene amplification tests and microarray tests) that can be performed on samples in certain restricted and/or advanced laboratory settings, very often some of these tests (i) may be complex, (ii) may require laboratory technicians to run, (iii) may be expensive, (iv) may require extensive computational information to interpret the data, and/or (v) may not exist at point-of-care and/or in outbreak zones. As a result, these tests may be often unavailable at the point-of-care, and/or may be of limited use in outbreak situations (where time may be of the essence). Other systems or methods of identification (e.g., malaria tests, immunochromatic strip tests or “ICT”), although readily available, may display limited sensitivity and/or specificity. Accordingly, they may have limited multiplex capacity, insofar as they may only test for one pathogen at a time. Moreover, such tests may provide little, if any, information on drug resistance and/or pathogen virulence.

As a result, the current standards of testing, measurement, detection and/or diagnosis of infectious diseases (whether performed in vivo, in serum, in vitro, and/or in silica) often may be technically outdated, expensive, imprecise, slow, of limited sensitivity and/or specificity, unavailable at the point-of-care, and/or ineffective in rapid identification and/or control of outbreaks, and may play extremely limited indirect roles in data gathering. In the event of an outbreak, or pandemic caused by an agent for which we lack a rapid diagnostic test (e.g., Severe Acute Respiratory Syndrome, alternately referred to as “SARS”), the standard of care may revert to a quarantine (i.e., a roughly 700 year old response), perhaps since current microbiologic diagnoses may be too slow, too imprecise, and/or too centralized to systematically diagnose large numbers of people. These shortcomings may prevent prompt and/or accurate diagnoses, treatment and/or containment of the outbreak and/or pandemic.

Accordingly, there may be a need for a system or method that provides for rapid or reliable measurements, detections, diagnoses, identifications and/or treatment of infectious diseases, preferably at the point-of-care, and preferably by utilizing previously collected measurement data, detection data, diagnosis data, identification data and/or treatment data, based on patients that exhibited similar symptoms and/or were infected by the same infectious disease(s).

Most new pathogens may originate in the developing world and spread to the developed world, thus creating a new age of infectious diseases which rapidly mutate and/or spread globally. As such, there may also be a need for system or method of data collection which provides for rapid identification and/or screening at points of entry and/or departure (e.g., airports, seaports, borders, sectors of the city or office buildings, hospitals, quarantine control points). Such a system or method may preferably help to re-focus medical care on the infected, on efficient processing of those not infected, and on provision of accurate information to decision makers and to the media.

The availability of such a system or method may also help to advance the capture, processing and/or distribution of data. As aforesaid, in the current medical model, data is collected for a particular patient and, once it has served its intended purpose, the data is seldom, if ever, referred to again. Preferably, such a system or method—by capturing otherwise ‘lost’ data, by pooling it with other data, and/or by analyzing the data for patterns and/or trends—may provide for construction of a powerful database, with socioeconomic benefits potentially stemming from the discounted, inexpensive, or free use of this database by governments (and/or healthcare agencies) so as to help tailor and/or direct existing resources, funding and/or programs to the area of the greatest need. Other benefits of such a system or method may include improved local, regional or global socioeconomic benefits. Still further benefits may include an improved ability for sales of test devices and/or services to generate revenue, and/or royalties or fees to companies (such as pharmaceutical companies) that access the database. Such revenue may be a secondary revenue stream earned, in addition to a primary revenue stream, by performing patient-specific diagnostic tests.

Part of the difficulty in collecting data may be that existing diagnostic equipment may not be designed with data collection objectives in mind. Alternately, if data may be collected in an electronic form, paper reports may be usually generated, and only these paper reports (if anything) may be retained. Also, different types of equipment may be used to gather the same general types of data, potentially leading to inconsistencies and/or incompatibilities in the data produced—i.e., since there may not be any common data structure, from one device and/or manufacturer to another. It may, therefore, be seen that providing devices (such as diagnostic and/or test devices) optimized and/or standardized for data collection (preferably, anonymized data collection) may be preferable, so as to maximize related capabilities, to increase quality or viability of analyzed patterns and/or trends, and/or to generate more and larger revenue streams from the collected data. Such a system or method may preferably collate local and global measurement, detection, or diagnostic data (alternately, referred to as “test data”) in one or more congruent and/or distributed databases, such as, for example, also including one or more sets of congruently inter-related databases.

The advantages of the system and method of the current invention may be enhanced when used with a test data collection device which collects a variable/standard/programmable data set for every patient, regardless of whatever preliminary diagnosis the physician has made. It may also be desirable to provide a system and/or method for collection of a data set which is programmable, substantially on demand, for specific uses in drug research and/or public health research.

Accordingly, there may be a need to provide data collection devices that are optimized and standardized for data collection, data transmission to the remote database and data retrieval from the remote database and/or from other data collection devices (such as diagnostic or test devices). The terms “data collection device”, “test device” and/or “diagnostic device” may herein be used interchangably.

There may also be a need to provide a method or system which provides for collection of data (from humans, animals and/or the environment) into an integrated database that is accessible from remote locations.

There may also be a need to provide a method or system which provides for analysis of data (collected from humans, animals and/or the environment) for trends and/or patterns, and preferably a method or system which makes the analyzed data available from remote locations.

It is an object of a preferred embodiment according to the present invention to provide a system and/or method which provides for collection of data from remote locations.

It is an object of a preferred embodiment according to the present invention to provide a system and/or method which provides for collection of data (alternately referred to as “diagnostic data” or “test data”) from remote locations into a remote database.

It is also an object of a preferred embodiment according to the present invention to provide a system and/or method which provides for access to data stored in a remote database. As before, and as used elsewhere herein, the term “remote database” may refer to one or more congruent and/or distributed databases, such as, for example, also including one or more sets of congruently inter-related databases.

It is an object of a preferred embodiment according to the present invention to provide a system and/or method which provides for analysis of data collected from remote locations for patterns and/or trends.

It is also an object of a preferred embodiment according to the present invention to provide a system and/or method which provides for access to the analyzed data from remote locations.

It is an object of a preferred embodiment according to the present invention to provide a system and/or method which provides for collection of data as a means to generate revenue for a business.

It is an object of the present invention to obviate or mitigate one or more of the aforementioned disadvantages associated with the prior art, and/or to achieve one or more of the aforementioned needs and/or objects of the invention.

### SUMMARY OF THE INVENTION

According to the invention, there is disclosed a method of storing, analyzing and enabling access to collected data and analyzed data. The collected data and the analyzed data are associated with one or more biological or environmental test subjects. The method includes: step (a) of electronically receiving test data, associated with at least one of the test subjects, using one or more test devices; step (b) of transmitting the test data to a remote database; step (c) of electronically storing the test data, as the collected data, in the remote database; step (d) of automatically analyzing the collected data to generate the analyzed data; step (e) of electronically storing the analyzed data in the remote database; and step (f) of enabling remote access to the collected data or the analyzed data, in the remote database, by one or more operatively accessing entities.

According to an aspect of one preferred embodiment of the invention, preferably in step (d), the collected data may preferably, but need not necessarily, be automatically processed by one or more pattern detection algorithms (such as, for example, trend detection algorithms), preferably to determine patterns therewithin. The patterns may preferably, but need not necessarily, form at least a part of the analyzed data.

According to an aspect of one preferred embodiment of the invention, preferably in step (a), medical data may preferably, but need not necessarily, be electronically received as the test data. The medical data may preferably, but need not necessarily, be associated with human or animal subjects as the test subjects.

According to an aspect of one preferred embodiment of the invention, the method may preferably, but need not necessarily, also include the step, preferably before step (d), of receiving and/or electronically storing epidemiological data, preferably as part of the collected data, and preferably in the remote database. Preferably in step (d), the collected data may preferably, but need not necessarily, be automatically processed by one or more pattern detection algorithms, preferably to determine biological and/or epidemiological patterns therewithin. The patterns may preferably, but need not necessarily, form at least a part of the analyzed data.

According to an aspect of one preferred embodiment of the invention, the method may preferably, but need not necessarily, also include the step, before step (d), of receiving and/or electronically storing geographical tracking data, preferably as part of the collected data, and preferably in the remote database. Preferably in step (d), the collected data may preferably, but need not necessarily, be automatically processed by one or more pattern detection algorithms, preferably to determine geographic patterns therewithin. The patterns may preferably, but need not necessarily, form at least a part of the analyzed data.

According to an aspect of one preferred embodiment of the invention, the method may preferably, but need not necessarily, also include the step, before step (d), of receiving and/or electronically storing temporal tracking data, preferably as part of the collected data, and preferably in the remote database. Preferably in step (d), the collected data may preferably, but need not necessarily, be automatically processed by one or more pattern detection algorithms, preferably to determine temporal patterns therewithin. The patterns may preferably, but need not necessarily, form at least a part of the analyzed data.

According to an aspect of one preferred embodiment of the invention, preferably in step (a), pathogen data or host data may preferably, but need not necessarily, be electronically received as the test data. The pathogen data or the host data may preferably, but need not necessarily, be associated with the aforesaid at least one of the test subjects.

According to an aspect of one preferred embodiment of the invention, the method may preferably, but need not necessarily, also include the step, preferably before step (f), of predetermining restricted access privileges, preferably for each of the operatively accessing entities, and preferably in dependent relation upon each variety of the collected data and/or the analyzed data in the remote database. Preferably in step (f), the access to the collected data and/or the analyzed data may preferably, but need not necessarily, be automatically restricted, preferably in keeping with the access privileges of each of the operatively accessing entities.

According to an aspect of one preferred embodiment of the invention, the test devices may preferably, but need not necessarily, automatically perform step (b), preferably after step (a), and preferably without user input.

According to an aspect of one preferred embodiment of the invention, preferably in step (f), a debit charge may preferably, but need not necessarily, be automatically applied, preferably to each of the operatively accessing entities, and preferably for remotely accessing the collected data and/or the analyzed data in the remote database.

According to an aspect of one preferred embodiment of the invention, the method may preferably, but need not necessarily, also include the step, preferably before step (a), of offering at least one of the test devices, and/or components for use therewith, preferably for sale and/or license to one or more technology end users.

According to an aspect of one preferred embodiment of the invention, preferably in step (a), the test devices may preferably, but need not necessarily, be for operative use by technology end users. The method may preferably, but need not necessarily, also include step (g) of enabling receipt of feedback, preferably from at least one of the technology end users and/or the accessing entities, and preferably concerning contemplated improvements to the test devices, the test data, the collected data, the analyzed data, the remote database, and/or the remote access.

According to an aspect of one preferred embodiment of the invention, the method may preferably, but need not necessarily, also include step (h), preferably after step (g), of implementing the contemplated improvements to the test devices, the test data, the collected data, the analyzed data, the remote database, and/or the remote access. The method may preferably, but need not necessarily, also include step (i) of offering the improvements, preferably for sale and/or license, and preferably to one or more of the technology end users and/or the accessing entities.

According to an aspect of one preferred embodiment of the invention, the method may preferably, but need not necessarily, also include step (j), preferably after step (i), of automatically applying an improvement debit, preferably to each of the accessing entities licensing the improvements to the collected data, the analyzed data, the remote database, and/or the remote access.

According to an aspect of one preferred embodiment of the invention, the method may preferably, but need not necessarily, also include step (k), preferably after step (i), of electronically receiving improvements to the test data, transmitting the improvements to the test data to the remote database, and/or electronically storing the improvements to the test data, preferably as part of the collected data, and preferably in the remote database.

According to an aspect of one preferred embodiment of the invention, the method may preferably, but need not necessarily, also include step (m), preferably after step (k), of automatically applying an improvement debit, preferably to each of the accessing entities licensing the improvements to the test data.

According to an aspect of one preferred embodiment of the invention, preferably in step (b), the test data may preferably, but need not necessarily, be wirelessly transmitted to the remote database, preferably via a wireless communication network.

According to an aspect of one preferred embodiment of the invention, the method may preferably, but need not necessarily, also include step (n) of operatively transmitting one or more messages from the remote database, preferably to the test devices. The messages may preferably, but need not necessarily, be electronically received by and/or displayed on the test devices.

According to an aspect of one preferred embodiment of the invention, preferably in step (n), wide area alerts may preferably, but need not necessarily, be operatively transmitted, preferably as the messages, and preferably to all of the test devices within a geographic region.

According to an aspect of one preferred embodiment of the invention, preferably in step (n), the messages may preferably, but need not necessarily, include directed alerts, preferably determined in dependent relation upon the test data operatively transmitted to the remote database in step (b).

According to an aspect of one preferred embodiment of the invention, preferably in step (n), the messages may preferably, but need not necessarily, include advertisements.

According to an aspect of one preferred embodiment of the invention, preferably in step (n), the advertisements may preferably, but need not necessarily, include directed advertisements, preferably determined in dependent relation upon the test data operatively transmitted to the remote database in step (b).

According to the invention, there is also disclosed a method for storing, analyzing and enabling access to collected data and analyzed data. The collected data and the analyzed data are associated with one or more biological or environmental test subjects. The method includes step (a) of electronically receiving collected data, associated with at least one of the test subjects, using one or more test devices. The method also includes step (b) of automatically processing and analyzing the collected data to wirelessly create a programmed or adaptive response effective in one or more peer devices. The peer devices are located remotely of the test devices and are in communication the one or more test devices via a wireless communication network. In this manner, a functioning of the one or more peer devices is wirelessly affected by the collected data electronically received by said one or more test devices.

According to an aspect of one preferred embodiment of the invention, preferably in step (b), the programmed and/or adaptive response may preferably, but need not necessarily, include a message electronically received within and/or displayed on the aforesaid at least one of the peer devices.

According to an aspect of one preferred embodiment of the invention, preferably in step (b), the message may preferably, but need not necessarily, include a wide area alert electronically received within and/or displayed on all of the peer devices within a geographic region.

According to an aspect of one preferred embodiment of the invention, the method may preferably, but need not necessarily, also include the step of electronically receiving collected peer data, associated with at least one of the test subjects, by said one or more peer devices. Preferably, in step (b), the message may preferably, but need not necessarily, include a directed warning alert, preferably determined in dependent relation upon the peer data.

According to an aspect of one preferred embodiment of the invention, the method may preferably, but need not necessarily, also include the step of electronically receiving collected peer data, associated with at least one of the test subjects, by said one or more peer devices. Preferably, in step (b), the programmed and/or adaptive response may preferably, but need not necessarily, be such that the collected peer data is determined in dependent relation upon the collected data electronically received by the aforesaid at least one of the test devices.

According to an aspect of one preferred embodiment of the invention, preferably at least a portion of step (b) may preferably, but need not necessarily, be performed remotely of at least one of the peer devices and/or the test devices.

According to the invention, there is also disclosed a system for storing, analyzing and enabling access to collected data and analyzed data. The collected data and the analyzed data are associated with one or more biological or environmental test subjects. The system includes one or more test devices, and a remote database in communication with the test devices. It also includes test data, associated with at least one of the test subjects, electronically received from the test devices. The test data is operatively transmitted to and electronically stored, as the collected data, in the remote database. The system also includes a processor operatively and automatically analyzing the collected data to generate the analyzed data. The analyzed data is electronically stored in the remote database. The system also includes an access subsystem operatively enabling remote access to the collected data or the analyzed data, in the remote database, by one or more accessing entities.

According to an aspect of one preferred embodiment of the invention, the processor may preferably, but need not necessarily, be operatively encoded to apply one or more pattern detection algorithms (such as, for example, trend detection algorithms), preferably to the collected data, and preferably to determine patterns therewithin. The patterns may preferably, but need not necessarily, form at least a part of the analyzed data.

According to an aspect of one preferred embodiment of the invention, the test data may preferably, but need not necessarily, include medical data, preferably associated with human and/or animal subjects as the test subjects.

According to an aspect of one preferred embodiment of the invention, the system may preferably, but need not necessarily, also include epidemiological data operatively received and/or electronically stored, preferably as part of the collected data, and preferably in the remote database. The processor may preferably, but need not necessarily, be operatively encoded to apply one or more pattern detection algorithms, preferably to the collected data, and preferably to determine biological and/or epidemiological patterns therewithin. The patterns may preferably, but need not necessarily, form at least a part of the analyzed data.

According to an aspect of one preferred embodiment of the invention, the system may preferably, but need not necessarily, also include geographic tracking data operatively received and/or electronically stored, preferably as part of the collected data, and preferably in the remote database. The processor may preferably, but need not necessarily, be operatively encoded to apply one or more pattern detection algorithms, preferably to the collected data, and preferably to determine geographic patterns therewithin. The patterns may preferably, but need not necessarily, form at least a part of the analyzed data.

According to an aspect of one preferred embodiment of the invention, the system may preferably, but need not necessarily, also include temporal tracking data operatively received and/or electronically stored, preferably as part of the collected data, and preferably in the remote database. The processor may preferably, but need not necessarily, be operatively encoded to apply one or more pattern detection algorithms, preferably to the collected data, and preferably to determine temporal patterns therewithin. The patterns may preferably, but need not necessarily, form at least a part of the analyzed data.

According to an aspect of one preferred embodiment of the invention, the test data may preferably, but need not necessarily, include pathogen data or host data, preferably associated with said at least one of the test subjects.

According to an aspect of one preferred embodiment of the invention, the access subsystem may preferably, but need not necessarily, include a set of restricted access privileges, preferably predetermined for each of the accessing entities, and preferably in dependent relation upon each variety of the collected data and/or the analyzed data in the remote database. Preferably, the access subsystem operatively and automatically restricts access to the collected data and/or the analyzed data, preferably in keeping with the access privileges of each of the accessing entities.

According to an aspect of one preferred embodiment of the invention, the test devices may preferably, but need not necessarily, automatically transmit the test data, preferably to the remote database, and preferably without user input.

According to an aspect of one preferred embodiment of the invention, the access subsystem may preferably, but need not necessarily, automatically apply a debit charge, preferably to each of the accessing entities, and preferably for remote access to the collected data and/or the analyzed data in the remote database.

According to an aspect of one preferred embodiment of the invention, the system may preferably, but need not necessarily, also include a technology offering subsystem, preferably to offer at least one of the test devices and/or components for use therewith, preferably for sale or license to one or more technology end users.

According to an aspect of one preferred embodiment of the invention, the test devices may preferably, but need not necessarily, be for operative use by technology end users. The system may preferably, but need not necessarily, also include an improvement subsystem operatively enabling receipt of feedback, preferably from at least one of the technology end users and/or the accessing entities, and preferably concerning contemplated improvements to the test devices, the test data, the collected data, the analyzed data, the remote database, and/or the remote access.

According to an aspect of one preferred embodiment of the invention, the improvement subsystem may preferably, but need not necessarily, operatively implement the contemplated improvements to the test devices, the test data, the collected data, the analyzed data, the remote database, and/or the remote access. The improvement subsystem may preferably, but need not necessarily, operatively offer the improvements, preferably for sale and/or license, and preferably to one or more of the technology end users and/or the accessing entities.

According to an aspect of one preferred embodiment of the invention, the improvement subsystem may preferably, but need not necessarily, automatically apply an improvement debit, preferably to each of the accessing entities licensing the improvements to the collected data, the analyzed data, the remote database, and/or the remote access.

According to an aspect of one preferred embodiment of the invention, the improvement subsystem may preferably, but need not necessarily, electronically receive improvements to the test data, transmit the improvements to the test data to the remote database, and/or electronically store the improvements to the test data, preferably as part of the collected data, and preferably in the remote database.

According to an aspect of one preferred embodiment of the invention, the improvement subsystem may preferably, but need not necessarily, automatically apply an improvement debit, preferably to each of the accessing entities licensing the improvements to the test data.

According to an aspect of one preferred embodiment of the invention, the system may preferably, but need not necessarily, also include a wireless communication network, preferably such that the remote database is in wireless communication with the test devices, and preferably such that the test data is wirelessly transmitted to the remote database.

According to an aspect of one preferred embodiment of the invention, the system may preferably, but need not necessarily, also include an alert subsystem operatively transmitting messages, preferably from the remote database, and preferably to the test devices. The messages may preferably, but need not necessarily, be electronically received by and/or displayed on the test devices.

According to an aspect of one preferred embodiment of the invention, the messages may preferably, but need not necessarily, include wide area alerts operatively transmitted to all of the test devices within a geographic region.

According to an aspect of one preferred embodiment of the invention, the messages may preferably, but need not necessarily, include directed alerts, preferably determined in dependent relation upon the test data operatively transmitted to the remote database.

According to an aspect of one preferred embodiment of the invention, the messages may preferably, but need not necessarily, include advertisements.

According to an aspect of one preferred embodiment of the invention, the advertisements may preferably, but need not necessarily, include directed advertisements, preferably determined in dependent relation upon the test data operatively transmitted to the remote database.

According to the invention, there is also disclosed a system for storing, analyzing and enabling access to collected data and analyzed data. The collected data and the analyzed data are associated with one or more biological or environmental test subjects. The system includes one or more test devices, and test data, associated with at least one of the test subjects, electronically received by the aforesaid at least one of the test devices as the collected data. The system also includes a wireless communication network in communication with the test devices, and one or more peer devices located remotely of the test devices. The peer devices are in communication with the wireless communication network, and with at least one of the test devices via the wireless communication network. The system also includes a processing subsystem operatively and automatically analyzing the collected data to create a programmed or adaptive response effective in at least one of the peer devices. In this manner, a functioning of the aforesaid at least one of the peer devices is affected by the collected data electronically received by said at least one of the test devices.

According to an aspect of one preferred embodiment of the invention, the programmed and/or adaptive response may preferably, but need not necessarily, include a message electronically received within and/or displayed on the aforesaid at least one of the peer devices.

According to an aspect of one preferred embodiment of the invention, the message may preferably, but need not necessarily, include a wide area alert electronically received within and/or displayed on one or more, or preferably on all, of the peer devices within a geographic region.

According to an aspect of one preferred embodiment of the invention, the system may preferably, but need not necessarily, also include collected peer data, preferably associated with at least one of the test subjects, and/or preferably electronically received by the aforesaid at least one of the peer devices. The message may preferably, but need not necessarily, include a directed warning alert, preferably determined in dependent relation upon the collected peer data.

According to an aspect of one preferred embodiment of the invention, the system may preferably, but need not necessarily, also include collected peer data, preferably associated with at least one of the test subjects, and/or preferably electronically received by the aforesaid at least one of the peer devices. The programmed and/or adaptive response may preferably, but need not necessarily, be such that the collected peer data is determined, preferably in dependent relation upon the collected data electronically received by said at least one of the test devices.

According to an aspect of one preferred embodiment of the invention, preferably at least a portion of the processing subsystem may preferably, but need not necessarily, be located remotely of at least one of the peer devices and/or the test devices.

Other advantages, features and/or characteristics of the present invention, as well as methods of operation and/or functions of the related elements of the method and system, and/or the combination of steps, parts and/or economies of manufacture, will become more apparent upon consideration of the following detailed description and the appended claims with reference to the accompanying drawings, the latter of which are briefly described hereinbelow.

### BRIEF DESCRIPTION OF THE DRAWINGS

The novel features which are believed to be characteristic of the system and method according to the present invention, as to their structure, organization, use, and method of operation, together with further objectives and advantages thereof, will be better understood from the following drawings in which presently preferred embodiments of the invention will now be illustrated by way of example. It is expressly understood, however, that the drawings are for the purpose of illustration and description only, and are not intended as a definition of the limits of the invention. In the accompanying drawings:

FIG. 1 is a flow chart schematically illustrating, in overview, one aspect of a method according to a preferred embodiment of the present invention;

FIG. 2 is block diagram illustrating generated revenue streams according to another preferred embodiment of the invention;

FIG. 3 is a block diagram schematically illustrating, in overview, another aspect of the method shown in FIG. 1;

FIG. 4 is a flow chart schematically illustrating, in detail, the method shown in FIGS. 1 and 3; and

FIG. 5 is a diagram illustrating, in overview, a system according to a preferred embodiment of the present invention.

### DETAILED DESCRIPTION OF THE PREFERRED EMBODIMENTS

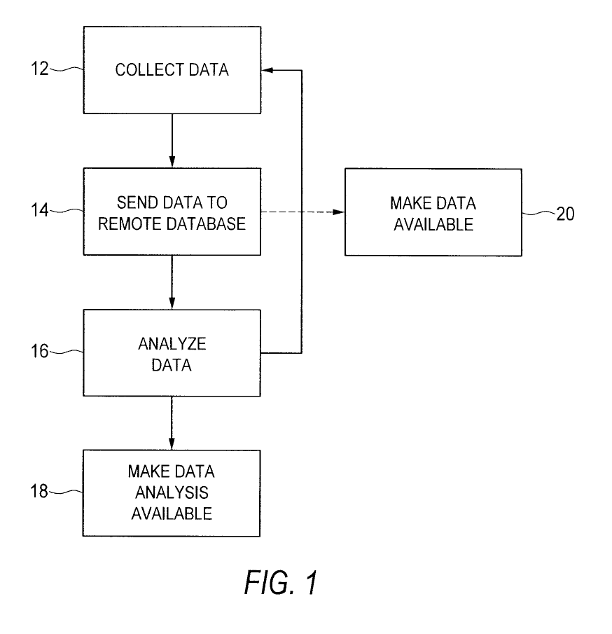

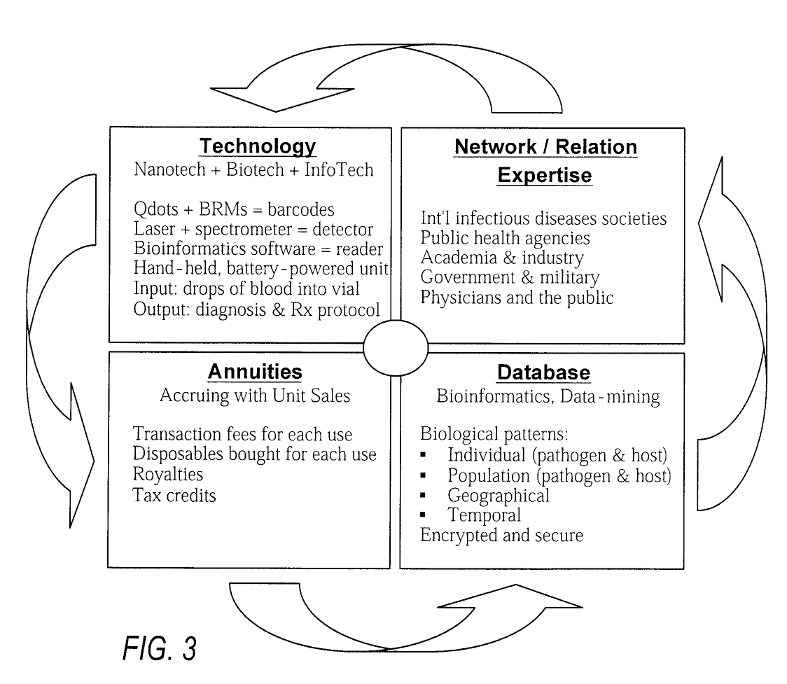

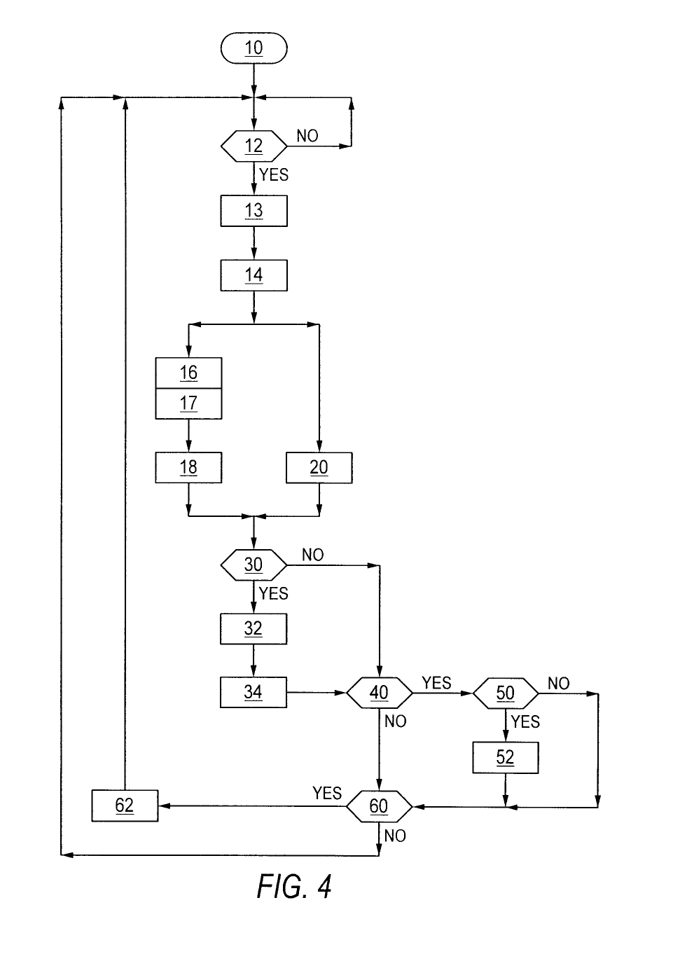

Referring now to FIGS. 1 and 3 of the drawings, there is schematically illustrated, in overview, a method according to one preferred embodiment of the present invention. FIG. 4 depicts certain aspects of the method in detail, and may be described in considerably greater detail elsewhere herein.

In FIG. 1, the present inventive method is described by a series of steps shown in a flowchart. In step 12, data is collected from a data source using a data collection unit. In the embodiment described herein, the data collected is preferably test data—including measurement data, detection data, and/or diagnostic data—such as might be gathered from a test device and/or computer and/or from in vivo, in serum, in vitro, and/or in silica sources. For example, the data may include pathogen identification data, data on previous drugs used, geographic and/or tracking (or other identifying) data, and/or epidemiological data (e.g., data on race and/or gender). The data may be gleaned from one or more environmental samples (e.g., soil samples, water samples, air samples) and/or biological samples (e.g., plant samples, animal samples, human samples)—such as, for example, blood samples, plasma samples, serum samples, urine samples.

The data collection unit, in one preferred embodiment, is a portable pathogen detection device that receives and analyzes the sample. As may be described elsewhere herein, numerous other types of data collection units are also capable of use in conjunction with preferred embodiments of the method and system according to the present invention.

The collected data is then transmitted, in step 14, to a remote database and/or analysis unit. The remote database may or may not be located centrally relative to the data collection units. As noted hereinabove, “remote database” may refer to one or more congruent and/or distributed databases, such as, for example, also including one or more sets of congruently inter-related databases. According to one or more preferred embodiments according to the present invention, the database(s) are provided remotely of the data collection units.

Preferably, this remote database constantly collects data from multiple remote data collection units and stores the collected data in the database. The collected data is then subject to analysis (in step 16) using different algorithms to detect trends and/or patterns within the collected data.

For example, pathogen data collected, collated, stored, and analyzed according to the present invention, may include a list of detected pathogens in a sample, as well as the geographic location(s) where the sample(s) may have been taken. By running one or more suitable algorithms against the location data associated with a specific pathogen, one or more locations where that pathogen is prevalent may be readily identified. While similar methods may be in existence for assessing outbreaks of infectious diseases after the fact, real-time collection and analysis of data may enable identification of an outbreak before it reaches a critical level.

Moreover, in a preferred embodiment according to the present invention, the remote database may be operable to transmit messages to the data collection units. Similarly, the data collection units may likewise be operable to receive the messages from the remote database and/or from other data collection units, and to display (or otherwise present) the received messages to the user. Such information may include alert information and/or bulletins, such as may be broadcast in conjunction with Health Care Organizations and/or local area hospitals. The alert information may include wide area warning alerts and/or directed warning alerts. The warning alerts may, in some preferred embodiments according to the present invention, be dependent upon the test data which is transmitted to the remote database. For example, upon receipt by the remote database of test data from a data collection unit which identifies a subject as having a susceptibility to a particular infectious disease, the remote database may transmit a warning back to that data collection unit concerning the prevalence of any relevant pathogens in the geographic region. Other messages may include advertisements intended for the subject or health care worker in the field. The advertisements may likewise be general or specific in nature. They may include advertisements for relevant drug treatments, and/or even a list of such drugs which may be specifically covered by the patient's health insurance.

From a business perspective, this method also enables an additional revenue stream to be added merely through data collection that would potentially occur as part of the main process. For example, diagnosis of pathogens for patients is a service for which the provider of the detection device receives payment. When the device is connected to the remote database (alternately referred to as a data storage repository) operated by the device provider, the provider can collate and analyze the data, which is collected as part of the measurement, detection, and diagnostic process. Thereafter, the provider can gain revenue through sale and/or distribution of the data analysis (alternately referred to as the analyzed data), and/or through providing (via selling and/or licensing) access to the collected data.

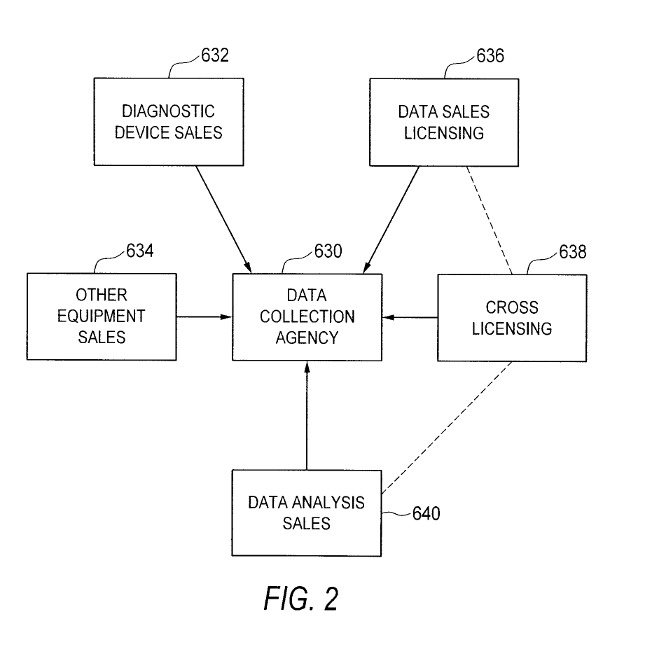

FIG. 2 illustrates the multiple potential revenue streams for a data collection agency 630. The first revenue stream is the sale (with the term “sale”, as used in this context and elsewhere herein, including leasing, licensing, etc.) of test devices 632 which additionally collect data. A spin-off revenue stream is the sale of other equipment 634 related to the device. For example, sales of a pathogen detection device would typically represent revenue of the first type, while sales of prepared sample vials, or other consumables for use with the device, may represent revenue of the second type.

The remaining revenue streams may be generated from (and/or associated with) the data collected. One such further revenue stream may be provided by the sale of the data itself 636, or the sale of access to the data, to interested parties. A further spin-off stream from this stream may include licensing and/or cross-licensing revenue 638 gained from research and/or development by the parties purchasing the data. (Of course, as used in this context and elsewhere herein, the term “purchasing” likewise includes leasing, licensing, etc.) A further revenue stream in this model is the sales of the data analysis results 640 (the “analyzed data”), or the sale of access to the analyzed data, to interested parties. These sales may also lead to licensing and/or cross-licensing revenue 638 as previously discussed. While it is anticipated that the majority of revenue-generating operations may fall into one or more of the aforementioned categories, it may also be possible to generate revenue from data collection in other ways that define their own type of revenue stream category.

In one preferred embodiment, the system includes an access subsystem and/or accounting subsystem which enable access to the collected data, and/or to the analyzed data, for a fee. Preferably, the test devices may be integrated with the accounting system such that payment for access to the remote database, and/or the automatic application of a debit charge to an end user, can be effected via the diagnostic device.

Payment (e.g., for access to the remote database, for continued use of a leased test device, etc.) may be made by various mechanisms, including prepaid systems, credit-based systems, subscription systems, pay-per-use systems, and/or using other accounting structures. For example, in a preferred pay-per-use embodiment, the user may pay for access each time data is transmitted to and/or requested from the remote database and/or other test devices. In a preferred prepaid-based embodiment, the user may prepay for a set number (or other quantum, whether measured in megabytes or bandwidth) of transmissions to and/or requests from the remote database and/or other test devices. In such a prepaid-based embodiment, the test devices may preferably be operable to display to the user the database access that has been utilized thus far, and/or the remaining access available (for which has been prepayment has been received). In a subscription-based embodiment, the user may pay a flat or variable rate for accessing the remote database and/or other test devices.

In a further preferred embodiment, the test devices also may be operable to (continuously or on demand) display, to the user, the status of their account and/or an alert if there is a deficiency and/or insufficiency in payment, which may require further funds be deposited and/or charged before continued access may be granted. It is additionally worthwhile to note that the transactions performed according to the present invention may be mediated transactions (e.g., involving one or more banks and/or other credit institutions), and/or direct transactions (e.g., between the service provider and the device user) with a mediated reconciliation transaction being made on a more or less regular basis (e.g., to settle an account).

In situations where data is provided directly between test devices, without otherwise involving the remote database and/or analysis unit, any direct transactions may be performed between test device users, and/or any mediated transactions may alternately involve the service provider.

Additional access fees may preferably be charged for access as between test devices. For example, a hospital may require an additional access fee before external test devices can obtain access to information gathered by test devices used by hospital staff. In some preferred embodiments, collected data (and/or analysis) may be accessed directly by a data transfer between test devices and/or via a reconciliation database.

A reconciliation database may be operable to mediate a transfer, and/or a transaction, between test devices.

In some preferred embodiments according to the present invention, the reconciliation database may mirror the remote database. Similarly, multiple mirror-image remote databases may be used according to the present invention, with data (and/or credit) reconciliations being performed on a more or less regular basis, in order to ensure appropriate back-up and integrity of the data contained in the remote database(s).

As indicated above, the reconciliation database may be operable to mediate the payment for access as between users and/or to set off amounts owed by first user to a second user against amounts owed by the second user to the first user.

Preferably, additional revenue may be generated via advertisements displayed on the test devices. For example, pharmaceutical companies seeking to market new drugs might pay to have the test devices display their advertisements.

One method of enhancing the quality and usefulness of the data collected is to design the data collection device with the intent of gathering, recording and transmitting as much data as possible to support the database. For example, a diagnostic device, such as a stethoscope, can be modified to include data collection and transmission elements in addition to the standard diagnostic elements. In a stethoscope, additional elements could include an audio recording device, to record the heartbeat without interfering with the audio input received by the doctor, a wireless transmitter, to transmit the recording to the database, and a GPS beacon, to provide time and location stamping to the recording. Similarly, other devices which may not heretofore have included test or diagnostic elements (such as laundry machines) might be modified to include test devices along with data collection and transmission elements.

Preferably, the modifications to the test device should not modify or otherwise interfere with (i) how the device is used to perform tests or diagnostics, and/or (ii) how the diagnostic or test data results are provided to the diagnosing doctor using the device. The data collection and transmission should be transparent, requiring little or no additional input from the doctor or the patient to successfully perform these functions.

Preferably, the system and method according to the present invention may be adapted to substantially guarantee the privacy of personal information for its associated test subjects. In this regard, governmental bodies dealing with the protection of privacy information may be allowed access to the system, and/or to the remote database, in order to confirm that privacy policies, legislation and/or regulations are being respected and/or complied with. As such, the system and method according to the present invention may enable an appropriate governing body to issue a certification of its compliance with one or more preferred privacy standards.

By making the data collection accessible, any privacy issues concerning the patient or test subject, who is the source of the data, may be avoided. The only information about the source of the data may be that contained in the data itself. While the diagnostic or test data may include identifiers such as gender, age, and/or race (and may preferably include one or more such identifiers for later trend and/or analysis purposes), there is a limited amount of information contained in the data to connect it to a specific individual. In some preferred embodiments, the test devices may themselves possess a limited ability to collect and/or deal with identifying data or personal information—e.g., to further ensure compliance with relevant privacy regulations. Automatic connection systems and/or integration of a data correlation components may preferably be used to ensure compliance with applicable privacy regulations.

At the database level, the collected data can be organized, collated, indexed and/or analyzed (“data mined”) for additional information. Trends—such as regional outbreaks of pathogens; gender-based or race-based (or regionally-based) susceptibility to diseases; etc.—can be determined by applying the appropriate algorithms to the available data. Additional trends and/or segmentations, such as population-based or locally-based segmentations, can be determined and/or performed by applying other algorithms to the data.

By collecting such information from variable/standard/programmable data sets from multiple sources, a vast global-level database of information can be rapidly developed. Such a database might be driven, for example, by routine testing. The mere existence of the database may represent its own revenue stream, since selected portions of the data might be sold to other entities for research purposes. Additionally, controls can be exercised such that only the aspects of the data necessary to fulfill any data request are provided to a requesting/accessing entity, with the remainder being either stripped out before transfer or blocked from access.

Similarly, multiple databases may preferably be maintained and/or the primary database may preferably be divided into sections to organize the data collected by the category of the diagnostic device which collected the data. Stethoscope data, MRI data, CT scan data, and/or pathogen data may all represent different types of diagnostic and/or test data which contain different information. This information may, in some preferred embodiments, vary in data type (e.g., audio files for stethoscopes, images for MRIs, sequence listings for pathogens) and/or in the patient information attached. The data retrieved by pathogen detection devices, for example, may be substantially more complex than that received from, for example, a stethoscope. Distinctions between the content of the data types may be readily apparent to persons having ordinary skill in the art.

Another advantage preferably afforded by the present invention may include the size of the database which is hereby taught. Previously, research and/or clinical trials typically may have been performed on small groups of volunteers. Even the largest trials may rarely have exceeded hundreds of test subjects. Research using the data collected in a database as described herein has the potential to provide millions of test subjects, either to provide direct value, or to steer any subsequent smaller trials with increased precision. As a result, research results can be consider more reliable, and research conducted in less time, leading to vast savings in time and money. For example, therapies and/or clinical trials can be customized to achieve better results with a reduction in the number of treatments, the number of trials, dosage amounts, side effects and/or costs. Based on the results of the tests performed according to the present invention, and based on the parameters and requirements for various known clinical trials in progress and upcoming, the system may preferably present from the test device a proposal that the patient may be a suitable candidate for participation in one or more of the clinical trials. Such customization of therapies may potentially be of great interest to insurance companies and to health care professionals in determining what therapies would produce the greatest results with the least side effects, lowest number of treatments, and/or lowest costs to both the patient and the health care system.

Additionally, as the data can be stripped of various identity information, leaving only those elements necessary to the research, the results from analyzing the data can be more objective than traditional test methods, which can be heavily subjective depending on the degree of input required from either the patient, the test subject, and/or doctor (or healthcare organization). Similarly, those data collected are more objective than subjective, as the doctor (or healthcare organization) and patient (or test subject) may not be involved in the aggregation process and/or any bias either party might otherwise have introduced into the data may thereby be eliminated. For example, patient information on smoking, alcohol use, and drug use can be determined from analysis of a blood sample and neither the patient nor doctor need be informed as to the results unless requested. Some of the data collected in this manner (e.g., data concerning drug abuse, etc.) might be used at a future point in time. As the data in the database may contain little or nothing to link it back to the original patient, it is less likely that any confidence may be breached. Nonetheless, future analysis of the data can take advantage of this additional information. In certain cases, this anonymity and ancillary data collection may prove more valuable than reliance on the subjective nature of patient questionnaires and volunteered information.

Similarly, government agencies can access the data for use generally in healthcare management, such as, for example, in developing budget estimates and/or in setting up treatment programs. If the data indicates that a pathogen, such as polio, is not present in the current population and/or has not been present for years, then a polio vaccination program might be terminated and/or the resources previously allocated to it may be applied elsewhere. As another example, the detection of a gradual increase in the incidence of sexually transmitted diseases among teenagers may suggest a need for increased resource allocations to sex education in high schools.

### The Method and System in the Business Context

As shown by the diagram in FIG. 3, the system and method of data collection is preferably used to create a self-sustaining and expanding business model based on circulating value. The model is based on four core assets: technology, annuities, database and network expertise.

The first core asset is the technology. The initial (inventive) technology may provide the initial drive for the business. As described herein, the core technology is preferably a combination of nanotechnology, biotechnology and information technology. The technology is preferably researched and developed to create the necessary hardware (e.g., a handheld detection device), software (e.g., bioinformatics database software), and consumables (e.g., sample vials).

In particular, transmissions from any kind of devices (e.g., point-of-care devices)_can provide therapeutic and/or other directly relevant information, and can represent a new technology development with substantial potential revenue growth. Previously, in order to keep costs as low as possible, point-of-care devices may typically have been limited to “yes/no” results (e.g., pregnancy tests) and/or may have lacked additional features. On the opposite end, advanced diagnostic technology previously may have been found in laboratories, but may not have been accessible to all patients, nor may the patient have been present for the testing. A device which bridges these two areas may be representative of the type of technology that drives the present business model.

The research and development of the technology leads to the creation of revenue streams through royalties, annuities, and/or transaction fees generated by the sale and/or licensing of the developed technology. Transaction fees, consumable fees, service contract fees, royalties on the database use, advertising fees, and/or annuities (which may themselves include transaction fees, consumable fees, service contract fees, royalties on the database use and/or advertising fees) may be derived in several ways. The most direct may be through hardware sales and licensing—i.e., the direct sale and/or licensing of handheld detection units. Such sales may preferably generate recurring revenue. Additionally, transaction fees may preferably be paid for use of equipment. Product revenue may also be generated through sales of disposable elements, such as the sample vials. Royalties and/or annuities received through database licensing and/or technology licensing can also be used as a supplemental and/or alternative source of revenue. There is also the potential for tax credits to be gained through the technology research and to be distributed to maximize profit gained from the revenues. A key aspect is that the annuities may preferably scale with unit sales and use. In this manner, an impetus may be provided for increased sales and/or distribution of the technology.

Next, data collection from the use of the technology may preferably be used to create one or more databases (whether a single congruent database, numerous mirror-image databases, and/or one or more distributed databases). The database(s) may preferably be linked to the growth of the annuities—i.e., since the annuities may preferably increase through the sale and/or use of the technology, more information may be gathered and the resulting database may become larger and/or more powerful.

As the database develops, the information may preferably be made available to numerous networks of expert parties (e.g., public health authorities, academia, industries, governments, special interest groups), one or more of whom may then provide their viewpoints and/or an indication of their needs concerning the database. Additional feedback may preferably be gained from users in the field (and/or potentially from the consumers) with respect to any hardware and/or software that may be currently deployed and/or used in conjunction with the system and method according to the present invention. One or more (and preferably all) aspects of the system and method may preferably tend toward a continually increase in the value of the database hardware and/or software of the database. Additionally, these aspects may also increase the value of the technology currently employed, and/or may help to set up a circulating knowledge management system, preferably so as to drive further developments in technology.

The feedback gained may preferably be used to drive new technology research to address the issues raised. As expertise is developed in using the database, it may preferably become apparent that additional advancements and/or improvements to the technology might be required in order to gain more value from the database. Additional benefits may preferably include advantages gained from building alliances—e.g., (a) business alliances, (b) alliances as between similar or different businesses, industries, universities, hospitals, institutions, and/or governments, (c) social or support communities and alliances as between people having the same diseases, ailments or conditions, (d) community alliances, and/or (e) alliances within the same or similar communities. Thus, a roadmap may preferably be provided to guide the research into new technologies. Furthermore, new and/or improved hardware and/or software might also preferably be developed, both to meet the needs of the users in the field and the requirements for the database, whether gleaned from or for use in the network communities and/or in communities of experts. The newly developed technologies may preferably help to fuel a new cycle, preferably including the development of: new annuity streams, improved databases, new and/or improved programming of the platforms for the new molecules and/or targets, and/or more expert and user feedback—any one or more of these factors driving still further new research and development. Preferably, the result is a circulating value business model which may provide for sustained revenue and growth from researched technologies.

The model preferably has particular application for uses in conjunction with point-of-care infectious disease diagnostic devices. Additional research into conjugates of biorecognition molecules with signature barcodes of quantum dots and/or fluorescent dyes can be used to further develop the devices. In addition, such devices may, according to at least some preferred embodiments, require consumables in the form of sample vials containing the conjugates. Thus, at the point of care, clinical samples may preferably become the input, with the devices providing an output, preferably in the form of a diagnosis along with a therapeutic protocol as retrieved and/or downloaded from one or more remote and/or on-board databases (e.g., including one or more distributed databases). The output could also include presentation of related continuing medical education materials, preferably also in conjunction with the subsequent offering of a credit for having undertaken the continuing medical education. Such a model may preferably have particular applications for use, and/or advantageous utility, in conjunction with clinical and/or public healthcare systems.

The technology may preferably thus generate revenue through the sale and/or licensing of the handheld devices, and/or through the sale of the consumables. Additionally, further revenue may preferably be derived from database access fees and/or transaction fees.

The data collected from the devices, in use, may preferably be collated and organized into a database as previously described herein. In addition to the data-mining capabilities provided by the database, it may also preferably provide a resource for expert parties. These expert parties, along with the users of the devices, may preferably generate feedback regarding the current technology, its use, and the content and efficiency of the database. This feedback may preferably help to direct the research into improvements in the devices, expansions (and/or refinements or improvements) in the scope of the current technology, and/or modifications to the database system and network.

As new technologies are released according to the preferred embodiment of the system and method, new revenue streams may preferably be created or embedded, and/or new or improved programming of the platforms for new molecules and/or targets may be provided, and the cycle will preferably continue. One preferable result may be a continued growth of revenues, preferably combined with continued research into and development of new technologies, while at the same preferably providing an invaluable source of epidemiological data (through the database).

We will now briefly address the inventive method from another direction, and with reference to FIG. 4. In FIG. 4, step 10 is the starting point. From there, the method proceeds to step 12, which queries whether test data has been collected with the test device. If no test data has been collected, the method returns again to step 12.

When test data has been collected, the method proceeds to step 13, wherein epidemiological data (e.g., gender-based data, age-based data, race-based data) is collected for each of the test data. Thereafter, the method proceeds to step 14, wherein the test data and the epidemiological data is preferably transmitted, as collected data, to the remote database.

At this point, the method splits into two branches. In one branch, the method proceeds to step 20, which enables restricted access to the collected data. In the other branch, in step 16, the collected data is analyzed to generate the analyzed data. In step 17, as part of the analyzed data, trend detection algorithms are run within collected data to determine patterns. Thereafter, in step 18, the method provides restricted access to the analyzed data.

In step 30, the method queries whether or not any new requests for access to the remote database have been received. If yes, then the method proceeds to step 32, wherein the accessing entity is debited. Thereafter, in step 34, restricted access to the collected data and/or the analyzed data is granted to the accessing entity based on the predetermined access privileges of same. From step 34, the method proceeds to step 40.

If, in step 30, no new requests for access to the remote database have been received, then the method proceeds directly to step 40.

In step 40, the method queries whether valuable feedback has been received from any of the accessing entities and/or the technology users. If yes, then the method proceeds to step 50, where it queries whether new technology is to be developed based on the feedback. If yes, then in step 52, the new technology is offered for sale or license. From step 52, the method proceeds to step 60.

If, in step 50, no new technology is to be developed based on the feedback, then the method proceeds directly to step 60.

If, in step 40, no valuable feedback has been received, then the method proceeds directly to step 60.

In step 60, the method queries whether there have been any new sales and/or licenses of the technology. If yes, then in step 62, the technology user is debited. From step 62, the method returns to step 12.

If, in step 60, no new sales or licenses of the technology have been made, then the method returns directly to step 12.

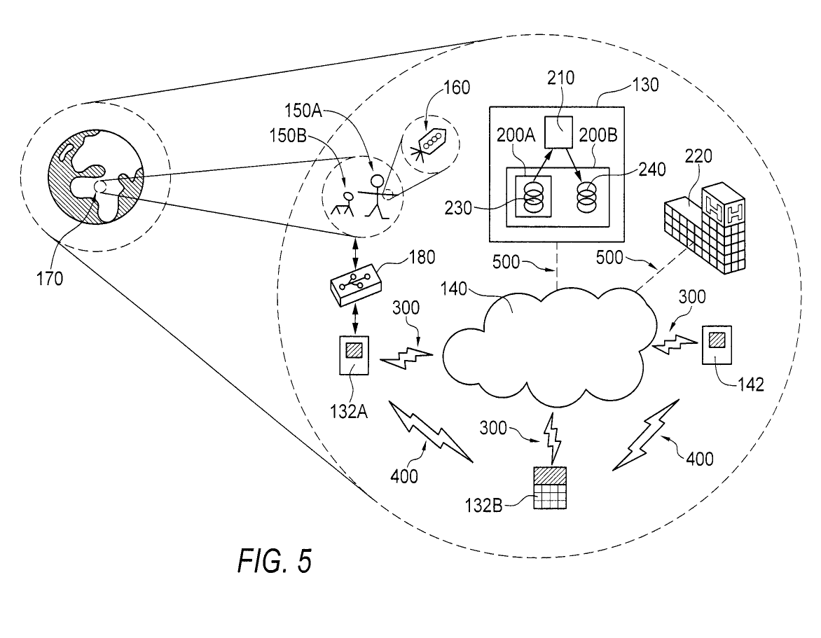

Reference will now be made, briefly in the context of FIG. 5, to the system according to one or more preferred embodiments of the present invention. The system is, preferably, for use with the method best seen in FIGS. 1 and 3-4 (and as described elsewhere herein). It should, of course, be appreciated that, according to the present invention, the system may be employed independent of the methods described elsewhere herein.

Now, therefore, the system may preferably include, and/or work in conjunction with, one or more of the following components, features and/or aspects: a remote database 130; system devices 132A, 132B; a system network 140; one or more outside devices 142; test subjects 150A, 150B (e.g., a human subject 150A, an animal subject 150B) situated at a geographic location 170; target molecules 160; a subject test sample 180; restricted access levels 200A, 200B to the remote database 130; a remote database processor 210 to analyze the collected data 230 and generate the analyzed data 240; an accessing entity 220; a system network connection 500 which may, in some preferred embodiments, be a wireless connection 300 to the system network 140; and/or a direct wireless connection 400 between system devices 132A, 132B and/or outside devices 142 (such that at least one of these devices 132A, 132B, 142 is capable of being referred to as a “test device” and at least one of them as a “peer device”).

This concludes the description of a presently preferred embodiment of the invention. The foregoing description has been presented for the purpose of illustration and is not intended to be exhaustive or to limit the invention to the precise form disclosed. Other modifications, variations and alterations are possible in light of the above teaching and will be apparent to those skilled in the art, and may be used in the design and manufacture of other embodiments according to the present invention without departing from the spirit and scope of the invention. It is intended the scope of the invention be limited not by this description but only by the claims forming a part of this application and/or any patent issuing herefrom.

1. A method of storing, analyzing and enabling access to collected data and analyzed data, with the collected data and the analyzed data being associated with one or more biological or environmental test subjects, the method comprising the steps of:
(a) electronically receiving test data, associated with at least one of the test subjects, using one or more test devices;
(b) transmitting the test data to a remote database;
(c) electronically storing the test data, as the collected data, in the remote database;
(d) automatically analyzing the collected data to generate the analyzed data;
(e) electronically storing the analyzed data in the remote database; and
(f) enabling remote access to the collected data or the analyzed data, in the remote database, by one or more operatively accessing entities.

2. A method according to claim 1, wherein in step (d), the collected data is automatically processed by one or more pattern detection algorithms to determine patterns therewithin, with the patterns forming at least a part of the analyzed data.

3. A method according to claim 1, wherein in step (a), medical data is electronically received as the test data, with the medical data being associated with human or animal subjects as the test subjects.

4. A method according to claim 3, further comprising the step, before step (d), of receiving and electronically storing epidemiological data, as part of the collected data, in the remote database; and wherein in step (d), the collected data is automatically processed by one or more pattern detection algorithms to determine biological or epidemiological patterns therewithin, with the patterns forming at least a part of the analyzed data.

5. A method according to claim 1, further comprising the step, before step (d), of receiving and electronically storing geographic tracking data, as part of the collected data, in the remote database; and wherein in step (d), the collected data is automatically processed by one or more pattern detection algorithms to determine geographic patterns therewithin, with the patterns forming at least a part of the analyzed data.

6. A method according to claim 1, further comprising the step, before step (d), of receiving and electronically storing temporal tracking data, as part of the collected data, in the remote database; and wherein in step (d), the collected data is automatically processed by one or more pattern detection algorithms to determine temporal patterns therewithin, with the patterns forming at least a part of the analyzed data.

7. A method according to claim 1, wherein in step (a), pathogen data or host data is electronically received as the test data, with the pathogen data or the host data being associated with said at least one of the test subjects.

8. A method according to claim 1, further comprising the step, before step (f), of predetermining restricted access privileges, for each of the operatively accessing entities, in dependent relation upon each variety of the collected data and the analyzed data in the remote database; and wherein in step (f), the access to the collected data or the analyzed data is automatically restricted in keeping with the access privileges of each of the operatively accessing entities.

9. A method according to claim 1, wherein the test devices automatically perform step (b), after step (a), without user input.

10. A method according to claim 1, wherein in step (f), a debit charge is automatically applied, to each of the operatively accessing entities, for remotely accessing the collected data or the analyzed data in the remote database.

11. A method according to claim 1, further comprising the step, before step (a), of offering at least one of the test devices, or components for use therewith, for sale or license to one or more technology end users.

12. A method according to claim 1, wherein in step (a), the test devices are for operative use by technology end users; and further comprising step (g) of enabling receipt of feedback from at least one of the technology end users or the accessing entities concerning contemplated improvements to the test devices, the test data, the collected data, the analyzed data, the remote database, or the remote access.

13. A method according to claim 12, further comprising step (h), after step (g), of implementing the contemplated improvements to the test devices, the test data, the collected data, the analyzed data, the remote database, or the remote access; and step (i) of offering the improvements for sale or license to one or more of the technology end users or the accessing entities.

14. A method according to claim 13, further comprising step (j), after step (i), of automatically applying an improvement debit to each of the accessing entities licensing the improvements to the collected data, the analyzed data, the remote database, or the remote access.

15. A method according to claim 13, further comprising step (k), after step (i), of electronically receiving improvements to the test data, transmitting the improvements to the test data to the remote database, and electronically storing the improvements to the test data, as part of the collected data, in the remote database.

16. A method according to claim 15, further comprising step (m), after step (k), of automatically applying an improvement debit to each of the accessing entities licensing the improvements to the test data.

17. A method according to claim 1, wherein in step (b), the test data is wirelessly transmitted to the remote database via a wireless communication network.

18. A method according to claim 1, further comprising step (n) of operatively transmitting one or more messages from the remote database to the test devices, wherein the messages are electronically received by and displayed on the test devices.

19. A method according to claim 18, wherein in step (n), wide area alerts are operatively transmitted, as the messages, to all of the test devices within a geographic region.

20. A method according to claim 18, wherein in step (n), the messages comprise directed alerts determined in dependent relation upon the test data operatively transmitted to the remote database in step (b).

21. A method according to claim 18, wherein in step (n), the messages comprise advertisements.

22. A method according to claim 21, wherein in step (n), the advertisements comprise directed advertisements determined in dependent relation upon the test data operatively transmitted to the remote database in step (b).

23. A method for storing, analyzing and enabling access to collected data and analyzed data, with the collected data and the analyzed data being associated with one or more biological or environmental test subjects, the method comprising the steps of:
(a) electronically receiving collected data, associated with at least one of the test subjects, using one or more test devices;
(b) automatically processing and analyzing the collected data to wirelessly create a programmed or adaptive response effective in one or more peer devices, with the peer devices being located remotely of the test devices and being in communication said one or more test devices via a wireless communication network, such that a functioning of said one or more peer devices is wirelessly affected by the collected data electronically received by said one or more test devices.

24. A method according to claim 23, wherein in step (b), the programmed or adaptive response comprises a message electronically received within and displayed on said at least one of the peer devices.

25. A method according to claim 24, wherein in step (b), the message comprises a wide area alert electronically received within and displayed on all of the peer devices within a geographic region.

26. A method according to claim 24, further comprising the step of electronically receiving collected peer data, associated with at least one of the test subjects, by said one or more peer devices; and wherein in step (b), the message comprises a directed warning alert determined in dependent relation upon the peer data.

27. A method according to claim 23, further comprising the step of electronically receiving collected peer data, associated with at least one of the test subjects, by said one or more peer devices; and wherein in step (b), the programmed or adaptive response is such that the collected peer data is determined in dependent relation upon the collected data electronically received by said at least one of the test devices.

28. A method according to claim 23, wherein at least a portion of step (b) is performed remotely of at least one of the peer devices or the test devices.

29. A system for storing, analyzing and enabling access to collected data and analyzed data, with the collected data and the analyzed data being associated with one or more biological or environmental test subjects, the system comprising:
(a) one or more test devices;
(b) a remote database in communication with the test devices;
(c) test data, associated with at least one of the test subjects, electronically received from the test devices, with the test data being operatively transmitted to and electronically stored, as the collected data, in the remote database;
(d) a processor operatively and automatically analyzing the collected data to generate the analyzed data, with the analyzed data being electronically stored in the remote database;
(e) an access subsystem operatively enabling remote access to the collected data or the analyzed data, in the remote database, by one or more accessing entities.

30. A system according to claim 29, wherein the processor is operatively encoded to apply one or more pattern detection algorithms to the collected data to determine patterns therewithin, with the patterns forming at least a part of the analyzed data.

31. A system according to claim 29, wherein the test data comprises medical data associated with human or animal subjects as the test subjects.

32. A system according to claim 31, further comprising epidemiological data operatively received and electronically stored, as part of the collected data, in the remote database; and wherein the processor is operatively encoded to apply one or more pattern detection algorithms to the collected data to determine biological or epidemiological patterns therewithin, with the patterns forming at least a part of the analyzed data.

33. A system according to claim 29, further comprising geographical tracking data operatively received and electronically stored, as part of the collected data, in the remote database; and wherein the processor is operatively encoded to apply one or more pattern detection algorithms to the collected data to determine geographic patterns therewithin, with the patterns forming at least a part of the analyzed data.

34. A system according to claim 29, further comprising temporal tracking data operatively received and electronically stored, as part of the collected data, in the remote database; and wherein the processor is operatively encoded to apply one or more pattern detection algorithms to the collected data to determine temporal patterns therewithin, with the patterns forming at least a part of the analyzed data.

35. A system according to claim 29, wherein the test data comprises pathogen data or host data associated with said at least one of the test subjects.

36. A system according to claim 29, wherein the access subsystem comprises a set of restricted access privileges predetermined, for each of the accessing entities, in dependent relation upon each variety of the collected data and the analyzed data in the remote database; and wherein the access subsystem operatively and automatically restricts access to the collected data or the analyzed data in keeping with the access privileges of each of the accessing entities.

37. A system according to claim 29, wherein the test devices automatically transmit the test data to the remote database, without user input.

38. A system according to claim 29, wherein the access subsystem automatically applies a debit charge, to each of the accessing entities, for remote access to the collected data or the analyzed data in the remote database.

39. A system according to claim 29, further comprising a technology offering subsystem to offer at least one of the test devices, or components for use therewith, for sale or license to one or more technology end users.

40. A system according to claim 29, wherein the test devices are for operative use by technology end users; and further comprising an improvement subsystem operatively enabling receipt of feedback from at least one of the technology end users or the accessing entities concerning contemplated improvements to the test devices, the test data, the collected data, the analyzed data, the remote database, or the remote access.

41. A system according to claim 40, wherein the improvement subsystem operatively implements the contemplated improvements to the test devices, the test data, the collected data, the analyzed data, the remote database, or the remote access; and wherein the improvement subsystem operatively offers the improvements for sale or license to one or more of the technology end users or the accessing entities.

42. A system according to claim 41, wherein the improvement subsystem automatically applies an improvement debit to each of the accessing entities licensing the improvements to the collected data, the analyzed data, the remote database, or the remote access.

43. A system according to claim 41, wherein the improvement subsystem electronically receives improvements to the test data, transmits the improvements to the test data to the remote database, and electronically stores the improvements to the test data, as part of the collected data, in the remote database.

44. A system according to claim 43, wherein the improvement subsystem automatically applies an improvement debit to each of the accessing entities licensing the improvements to the test data.

45. A system according to claim 29, further comprising a wireless communication network, such that the remote database is in wireless communication with the test devices, and the test data is wirelessly transmitted to the remote database.

46. A system according to claim 29, further comprising an alert subsystem operatively transmitting messages from the remote database to the test devices, with the messages being electronically received by and displayed on the test devices.

47. A system according to claim 46, wherein the messages comprise wide area alerts operatively transmitted to all of the test devices within a geographic region.

48. A system according to claim 46, wherein the messages comprise directed alerts determined in dependent relation upon the test data operatively transmitted to the remote database.

49. A system according to claim 46, wherein the messages comprise advertisements.

50. A system according to claim 49, wherein the advertisements comprise directed advertisements determined in dependent relation upon the test data operatively transmitted to the remote database.

51. A system for storing, analyzing and enabling access to collected data and analyzed data, with the collected data and the analyzed data being associated with one or more biological or environmental test subjects, the system comprising:
(a) one or more test devices;
(b) test data, associated with at least one of the test subjects, electronically received by said at least one of the test devices as the collected data;
(c) a wireless communication network in communication with the test devices;
(d) one or more peer devices located remotely of the test devices, with the peer devices being in communication with the wireless communication network, and with at least one of the test devices via the wireless communication network;
(e) a processing subsystem operatively and automatically analyzing the collected data to create a programmed or adaptive response effective in at least one of the peer devices, such that a functioning of said at least one of the peer devices is affected by the collected data electronically received by said at least one of the test devices.

52. A system according to claim 51, wherein the programmed or adaptive response comprises a message electronically received within and displayed on said at least one of the peer devices.

53. A system according to claim 52, wherein the message comprises a wide area alert electronically received within and displayed on all of the peer devices within a geographic region.

54. A system according to claim 52, further comprising collected peer data, associated with at least one of the test subjects, electronically received by said at least one of the peer devices; and wherein the message comprises a directed warning alert determined in dependent relation upon the collected peer data.

55. A system according to claim 51, further comprising collected peer data, associated with at least one of the test subjects, electronically received by said at least one of the peer devices; and wherein the programmed or adaptive response is such that the collected peer data is determined in dependent relation upon the collected data electronically received by said at least one of the test devices.

56. A system according to claim 52, wherein at least a portion of the processing subsystem is located remotely of at least one of the peer devices or the test devices.
